(19) United States
(12) Patent Application Publication
(10) Pub. No.: US 2024/0375497 A1
(43) Pub. Date: Nov. 14, 2024

(54) Embedded car cover

(71) Applicant: ZHEJIANG SURPASS AUTO PARTS CO.,LTD., Wenzhou City (CN)

(72) Inventors: Shiqi Zheng, Wenzhou City (CN); Dongdong Wang, Wenzhou City (CN); Yien Wang, Wenzhou City (CN); Yi Lin, Wenzhou City (CN); Lei Lin, Wenzhou City (CN)

(21) Appl. No.: 18/331,560

(22) Filed: Jun. 8, 2023

(30) Foreign Application Priority Data
May 9, 2023 (CN) 202310524239.8

(51) Int. Cl. B60J 7/14

(52) U.S. Cl. CPC B60J 7/141

(57) ABSTRACT

The present invention discloses a splice plate car cover including a first splice section and a second splice section, the first splice section includes a seal section and a deformation section, the seal section is provided with a first flange and a second concave edge, the deformation section is provided with a thin wall section and a press pivot, the second splice section includes a fitting section and a clamping section, the fitting section is provided with a first concave edge and a second flange, the first flange is adapted to the first concave edge, the second flange is adapted to the second concave edge, the press pivot is provided in correspondence with the fitting section, the press pivot to deform the deformation section and make contact with the clamping section. The invention by the cooperation of sealing part and fitting section, the first flange, the first concave edge, the second flange, the second concave edge work together to form an “S” shape sealing structure, with very good waterproof effect.

### TECHNICAL FIELD

This invention is relevant to splice plates, especially a splice plate car cover.

### BACKGROUND TECHNOLOGY

The pick-up truck (also known as a sedan truck) is used for carrying goods. Since the pick-up truck's cargo hopper is open, a cover was invented to prevent the goods inside the cargo hopper from getting wet in the rain and snow, by installing the cover on the pick-up truck's cargo hopper and using the cover to cover the goods inside the hopper to prevent the goods inside the hopper from getting wet in the rain.

Most of the existing covers are made by connecting several plates through a rotating shaft structure and then placing them on the cargo hopper. This structure makes it impossible to adjust the size of each plate of the cover and the accessories connected to it are relatively fixed and cannot be modified according to customer preferences.

### ABOUT THE INVENTION

The purpose of the invention is to provide a plate car cover to solve the existing problems of fixed size and single function of car covers.

In order to solve the above problems of the existing technology, the technical solution adopted in the invention is as follows.

A splice plate car cover includes a plurality of splice plate groups, with two adjacent splice plate groups connected to each other by a rotating shaft system, the splice plate groups include any one or a combination of a blind plate, a large groove plate and a small groove plate, the large groove plate and the small groove plate are used for connecting a plate fixing system and can be fitted with different sizes of plate fixing system with a splice plate wrench system or a splice plate lock bolt system, and with no limitation as to whether they are fitted to the large groove plate or to the small groove plate according to demand. The widths of the large splice groove plate, the small splice groove plate and the blind splice plate are not at least identical.

The car cover can be a plurality of blind plate connected to each other, a plurality of large groove plates connected to each other, a plurality of small groove plates connected to each other, or a combination of a blind plate and a large groove plate connected to each other, a combination of a blind plate and a small groove plate connected to each other, a combination of a large groove plates and a small groove plates connected to each other, or a combination of a large groove plates, small groove plates and blind plate connected to each other, or any combination of blind plates, large groove plates and small groove plates. And the dimensions of each splice plate (large groove plate, small groove plate, blind plate) can be identical or different.

Further, it includes a front fixing bracket, a left fixing bracket, a rear fixing bracket and a right fixing bracket, the front fixing bracket and rear fixing bracket are respectively connected to two ends of the splice plate group, the left fixing bracket and the right fixing bracket are respectively connected to the other two ends of the splice plate group.

Further, it includes a sealing rubber strip, the waterproofing rubber strip is provided at the junction of the blind plate, the large groove plate and the small groove plate.

Further, the blind plate, the large groove plate and small groove plate are connected with a splice structure, the splice structure includes a first splice section and a second splice section, the first splice section is adapted to the second splice section, by providing a first splice structure and a second splice structure at the ends of the blind plate, the large groove plate and the small groove plate respectively, the users can choose the quantity and size of the spliced plates they need to meet their individual requirements.

Further, the blind plate, the large groove plate and the small groove plate are all connected with a splice structure, the splice plate is connected with a first splice section or a second splice section, the first splice section or the second splice section is connected to one end of the splice plate, the first splice section is adapted to the second splice in the middle of the splice plate, as both ends of the splice plate need to be connected to splice plate, therefore a splice structure need to be provided at both ends of the splice plate, usually only one side of the end splice plate is needed to be connected to the splice plate, so only one splice section is needed.

Further, the first splice section includes a sealing section and a deformation section, the sealing section is provided with a first flange and a second concave edge, the deformation section is provided with a thin wall section and a press pivot point, the second splice section includes a fitting section and a clamping section, the fitting section is provided with a first concave edge and a second flange, the first flange is adapted to the first concave edge, the second flange is adapted to the second concave edge, the press pivot point is provided in correspondence with the clamping section, the press pivot point is used to deform the deformation section in contact with the clamping section, through the cooperation of the sealing part and the fitting section, the first flange, the first concave edge, the second flange and the second concave edge work together to form an “S” type sealing structure with good waterproof effect, by providing a press pivot point and a thin-walled section, the deformed section is deformed in the thin-walled section by pushing the press pivot point, which in turn clamps the first splice to the second splice, forming a splicing structure. The said second concave edge and second flange cooperate to increase stability, provide splicing positioning and also play a certain role in waterproofing.

Further, the first splice section further includes a connection section, the sealing section is connected to the deformation section through the connection section, the thin wall section is provided between the pressing pivot point and the connection section, the second splice section further includes an intermediate section, through which the fitting section is connected to the clamping section, the sealing section is provided with a first rubber strip pressing surface, the fitting section is provided with a second rubber strip pressing surface, a sealing rubber strip is provided between the first rubber strip pressing surface and the second rubber strip pressing surface, the clamping section is provided with a third flange, the deformation section is provided with a third concave edge, the third flange is adapted to the third concave edge, the third concave edge is provided at the end of the pressing pivot point away from the thin wall section, the deformation section is connected to the clamping end at the end away from the connection section, the clamping end is provided at the side of the deformation section near the clamping section, by providing the sealing rubber strip and setting the first rubber strip pressing surface and the second rubber strip pressing surface on both sides of the sealing rubber strip, when the pressing pivot point is pressed, the third flange cooperate with the third concave edge, the clamping end in contact with the clamping section and continues to apply pressure to the press pivot so that the clamping end hooks onto the third flange, at the same time, the second splice section is deformed by the force, causing the rubber strip pressing surface to press against the sealing rubber strip, clamping the sealing rubber strip between the first rubber strip pressing surface and the second rubber strip pressing surface. as the first flange is stuck inside the first concave edge, the clamping end is also stuck with the clamping section, thus the two ends of the first splice structure clamp the second splice structure to realize the connection of two splice structures, when the press pivot of the blind plate is squeezed, the thin walled part is easily deformed, so that the deformation section is deformed, the first deformation transfer surface applies the force to the second deformation transfer surface, causing the middle part to deform, the second rubber strip press surface squeezes the sealing rubber strip, and the first rubber strip press surface presses the sealing rubber strip in reverse, deforming the sealing rubber strip.

Further, the splice plate group includes a first splice plate group, a second splice plate group and a third splice plate group, the first splice plate group and the second splice plate group are connected to each other by a rotating shaft system, the second splice plate group and the third splice plate group are connected to each other by a rotating shaft system, the first splice plate group includes a large groove plate and a blind plate, the large groove plate is connected with a wrench system, the second splice plate group includes a small groove plate, a large groove and a blind plate, the large groove plate is connected between the small groove plate and the blind plate, the large groove plate is connected with a wrench system, the third splice plate group includes a small groove plate, a blind plate and two large groove plates, the two large groove plates are connected to each other, the two large groove plates are connected with a small groove plate and a blind plate, one of the large groove plates is connected with a wrench system.

Further, the splice plate group includes a first splice plate group, a second splice plate group and a third splice plate group, the first splice plate group and the second splice plate group are connected to each other by a rotating shaft system, the second splice plate group and the third splice plate group are connected to each other by a rotating shaft system, the first splice plate group includes a blind plate and a small groove plate, the small groove plate is connected with a lock bolt system, the second splice plate group includes a small groove plate, a large groove and a blind plate, the large groove plate is connected between the small groove plate and the blind plate, the large groove plate is connected with a wrench system, the third splice plate group includes a small groove plate, a blind plate and two large groove plates, the two large groove plates are connected to each other, the two large groove plates are respectively connected to a small groove plate and a blind plate, the small groove plates are connected to a lock bolt system.

Further, the splice plate group includes a first splice plate group, a second splice plate group and a third splice plate group, the first splice plate group and the second splice plate group are connected to each other by a rotating shaft system, the second splice plate group and the third splice plate group are connected to each other by a rotating shaft system, the first splice plate group includes a blind plate and a small groove plate, the small groove plate is connected with a lock bolt system, the second splice plate group includes a small groove plate, a large groove and blind plate, the large groove plate is connected between the small groove plate and the blind plate, the small groove plate is connected with a lock bolt system, the third splice plate group includes a small groove plate, a blind plate and two large groove plates, the two large groove plates are connected to each other, the two large groove plates are respectively connected with a small groove plate and a blind plate, the small groove plate is connected with a lock bolt system.

A splice plate car cover including a plurality of splice plate groups, with two adjacent splice plate groups connected to each other by a rotating shaft system, the splice plate groups include any one or a combination of a blind plate, a large groove plate and a small groove plate, the large groove plate and the small groove plate are used for connecting a plate fixing system. The large and small groove plates can be fitted with different sizes of plate fixing systems, with a splice plate wrench system or with a splice plate lock bolt system, and are not limited to whether they are fitted to the large or small groove plate according to demand. the width dimensions of the splice large groove plate, the splice small groove plate and the blind plate are not at least identical, by setting the splice plate, it can be adapted accordingly to the user's needs and meet the individual needs of different users, the splicing plate group can include only any one of the blind plate, the large groove plate, the small groove plate, or any two of the blind plate, the large groove plate and the small groove plate. The width of each splice plate may or may not be identical.

Further, it includes a front fixing bracket, a left fixing bracket, a rear fixing bracket and a right fixing bracket, the front fixing bracket and the rear fixing bracket are respectively connected to opposite ends of the splice plate group, the left fixing bracket and the right fixing bracket are respectively connected to the other two ends of the splice plate group. The large and small groove panels can be installed without the fixing system, which is mounted on the front or rear fixing frame.

Further, the second splice section includes a fitting section and a clamping section, the fitting section is provided with a first concave edge and a second flange, the first flange is adapted to the first concave edge while the second flange is adapted to the second concave edge, the pressing pivot point is provided in correspondence with the clamping section, the pressing pivot point is used to deform the deformation section and contact with the clamping section, through the cooperation of the sealing section and the fitting section, the first flange, the first concave edge, the second flange and the second concave edge work together to form an “S”-shaped sealing structure, which has a good waterproof effect.

Further, the first splice section includes a connection section, through which the sealing section is connected to the deformation section, the thin wall section is provided between the pressing pivot and the connection section, the second splice section also includes an intermediate section, through which the fitting section is connected to the clamping section.

The beneficial effects of the invention are as follows.

The splice structure can not only play the role of connection, but also has a very good waterproof effect, so that it is more widely applicable.

2. By providing a press pivot point and a thin wall section, the deformation section is deformed in the thin wall section by pushing the press pivot point, thereby clamping the first splice section to the second splice section and forming a splice structure, which is stable and not easy to break after connection

3. By setting the spliceable plate, the width of the splice plate can be combined according to the customer's requirements, the large groove plate and the small groove plate can be connected to some car cover components, and through different combinations, different components can be selected so as to meet different needs.

### DESCRIPTION OF DRAWINGS

FIG. 1 is the structure schematic diagram 1 of the car cover of the invention.

FIG. 2 is the structure schematic diagram 2 of the car cover of the invention.

FIG. 3 is the structure schematic diagram 3 of the car cover of the invention.

FIG. 4 is the structure schematic diagram of Embodiment 15 in the invention.

FIG. 5 is the structure schematic diagram of Embodiment 16 in the invention.

FIG. 6 is the structure schematic diagram of Embodiment 17 in the invention.

FIG. 7 is the partial enlarged view 1 of part A in FIG. 4.

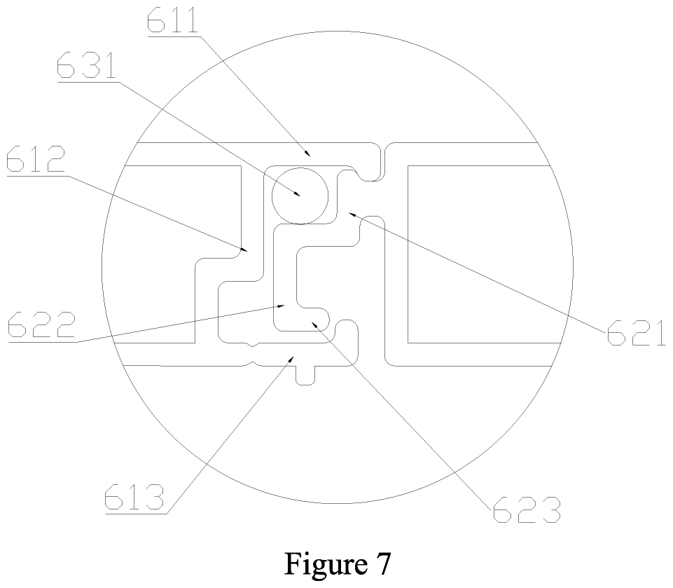

FIG. 8 is the partial enlarged view 2 of part A in FIG. 4.

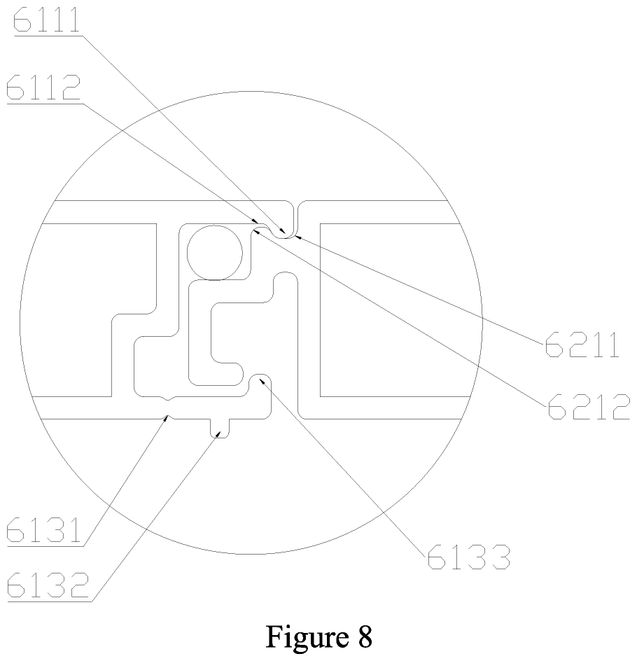

FIG. 9 is the partial enlarged view 3 of part A in FIG. 4.

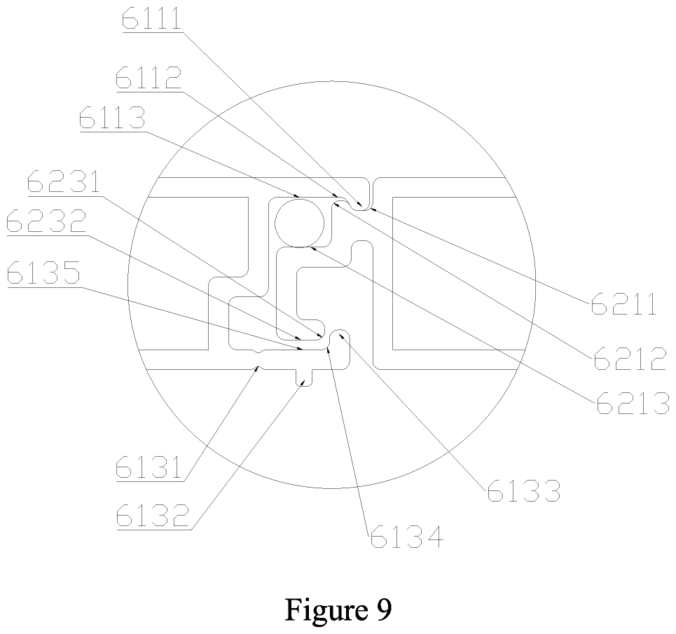

In the figures: 1—Front fixing bracket; 2—Left fixing bracket; 3—Rear fixing bracket; 4—Right fixing bracket; 5—Splice plate group; 51—Small groove plate; 52—Large groove plate; 53—blind plate; 54—Lock bolt system; 55—Wrench system; 56—Rotating shaft system; 611—Sealing section; 6111—First flange; 6112—Second concave edge; 6113—First rubber strip pressing surface; 612—Connection section 613—Deformation section; 6131—Thin wall section; 6132—Pressing pivot point; 6133—Clamping end; 6134—Third concave edge; 6135—First deformation transfer surface; 621—Fitting section; 6211—First concave edge; 6212—Second flange; 6213—Second rubber strip pressing surface; 622—Intermediate section; 623—Clamping section; 6231—Third flange; 6232—Second deformation transfer surface; 631—Sealing rubber strip.

### The Concrete Method to Carry out

The following instruction further explains the invention's concrete implementation method.

In order to enable a clearer understanding of the objects mentioned above, features and advantages of the present invention, the invention is described in detail below in connection with the accompanying drawings and specific embodiments. It should be noted that the embodiments of the present invention and the features in the embodiments can be combined without conflict.

The terms “first”, “second”, “third”, etc. are only used to differentiate the description and should not be construed as indicating or implying relative importance.

In the description of the invention, it should also be noted that, unless otherwise expressly specified and limited, the terms “arranged,” “installed,” “connected,” and “combined” should be understood in a broad sense. for example, it may be a fixing connection, it can also be a detachable connection or an integral connection. it can be a mechanical connection or an electrical connection. it can be a direct connection or an indirect connection through an intermediate media. And it can be internal connection within two assemblies. For those of ordinary skill in this field, specific meanings of the above terms in the present invention can be understood in specific situations.

The specific embodiments of the present invention will be described in detail below in connection with the accompanying drawings. It should be understood that the specific embodiments described herein are intended only to illustrate and explain the present invention and not to limit it.

### Embodiment 1

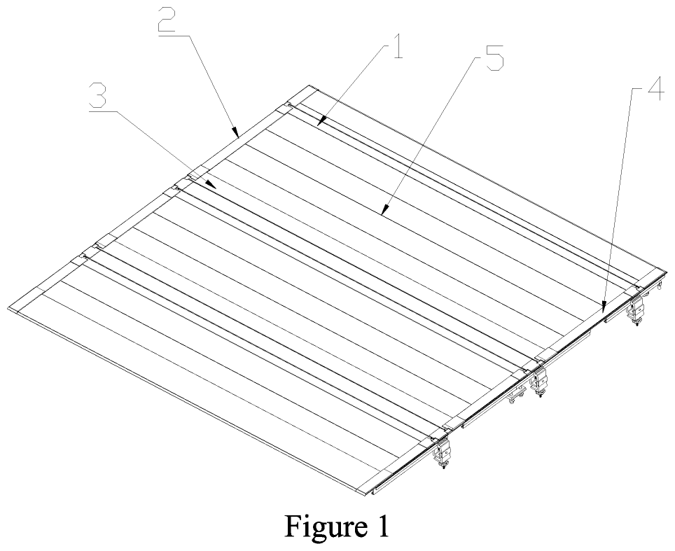

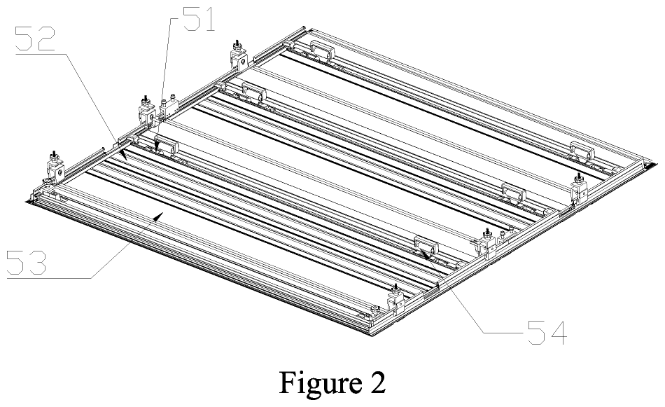

As shown in FIGS. 1 and 2, a splice plate car cover including a splice plate group 5, the splice plate groups include any combination of a blind plate 53, a large groove plate 52 and a small groove plate 51 (Any combination here can be a single blind plate 53, a large groove plate 52 or a small groove plate 51, or a combination of blind plate 53, a large groove plate 52 and a small groove plate 53, with no limit on the number and size of a blind plate 53, a large groove plate 52 and a small groove plate 53 in the process of combination, which can be adjusted as required), the large groove plate 52 and the small groove plate 51 are used for connecting a plate fixing system and can be fitted with different sizes of plate fixing system, with a splice plate wrench system 55 or with a splice plate lock bolt system 54 with no limitation as to whether they are fitted to the large groove plate 52 or to the small groove plate 51 according to demand. Moreover, the large groove plate 52 and the small groove plate 51 can be fitted without the fixing system. The widths of the large groove plate 52, the small groove plate 51 and the blind plate 53 are not at least identical.

### Embodiment 2

As shown in FIGS. 1 and 2, a splice plate car cover includes splice plate group 5, the splice plate group 5 includes any combination of blind plate 53 and large groove plate 52, the large groove plate 52 is used to connect to the plate fixing system and can be fitted with a splice plate wrench system 55 or with a splice plate lock bolt system 54, while the large groove plate 52 can be fitted without the fixing system. The width dimensions of both the large groove plate 52 and the blind plate 53 may be the same or different.

### Embodiment 3

As shown in FIGS. 1 and 2, a splice plate car cover includes splice plate group 5, the splice plate group 5 includes any combination of blind plate 53 and small groove plate 51, the large groove plate 52 is used to connect the plate fixing system and can be fitted with a splice plate wrench system 55 or with a splice plate lock bolt system 54, while the small groove plate 51 can be fitted without the fixing system. The width dimensions of the small slotted plate 51 and the blind plate 53 may be the same or different.

### Embodiment 4

As shown in FIGS. 1 and 2, a splice plate cover includes a splice plate group 5, the splice plate group 5 includes any combination of a large groove plate 52 and a small groove plate 51, the small groove plate 51 and the large groove plate 52 are both used to connect to a plate fixing system and can be fitted with a splice plate wrench system 55 or a splice plate lock bolt system 54, with no limitation as to whether the large groove plate 52 or the small groove plate 51 is fitted according to demand. The large groove plate 52 and the small groove plate 51 can be installed without the fixing system. The width dimensions of the small groove plate 51 and the large groove plate 52 can be the same or different.

### Embodiment 5

As shown in FIGS. 1 and 2, a splice plate cover includes a splice plate group 5, the splice plate group 5 includes at least one large groove plate 52, the large groove plate 52 is used to connect the plate fixing system and can be fitted with a splice plate wrench system 55 or with a splice plate lock bolt system 54, the large groove plate 52 can be in different width, and the large groove plate 52 can be fitted without the fixing system.

### Embodiment 6

As shown in FIGS. 1 and 2, a splice plate car cover includes a splice plate group 5, the splice plate group 5 includes at least one small groove plate 51, the small groove plate 51 is used to connect the plate fixing system and can be fitted with a splice plate wrench system 55 or with a splice plate lock bolt system 54, the small groove plate 51 can be in different width, and the small groove plate 51 can be fitted without a fixing system.

### Embodiment 7

As shown in FIGS. 1 and 2, a splice plate cover includes a splice plate group 5, the splice plate group 5 includes at least one blind plate 53, the blind plate 53 can be machined to connect with a fixing groove for mounting a plate fixing system, the fixing groove can be fitted with a splice plate wrench system 55 or with a splice plate lock bolt system 54, the blind plate 53 can be of different width sizes and the blind plate 53 can be fitted without a fixing system, and the splice plate blind 53 can also be without machining. The splice plate blind 53 can be in different width.

### Embodiment 8

As shown in FIGS. 1 and 2, a splice plate cover includes a front fixing bracket 1, a left fixing bracket 2, a rear fixing bracket 3, a right fixing bracket 4 and a splice plate group 5, the front fixing bracket 1 and rear fixing bracket 3 are respectively connected to the two ends of the splice plate group 5, the left fixing bracket 2 and the right fixing bracket 4 are respectively connected to the other two ends of the splice plate group 5, the splice plate group 5 includes at least one blind plate 53, the plate fixing system is connected to the front fixing bracket 1 or the rear fixing bracket 3. The splice plate blind 53 are vary in width.

### Embodiment 9

On the basis of any of Embodiment 1-7, a splice plate cover further includes a front fixing bracket 1, a left fixing bracket 2, a rear fixing bracket 3 and a right fixing bracket 4, the front fixing bracket 1 and rear fixing bracket 3 are respectively connected to the two ends of the splice plate group 5, and the left fixing bracket 2 and the right fixing bracket 4 are respectively connected to the other two ends of the splice plate group 5.

### Embodiment 10

On the basis of Embodiment 8 or 9, it also includes a sealing rubber strip 631, the waterproofing strip is provided at the junction of the blind plate 53, the large groove plate 52 and the small groove plate 51.

The blind plate 53, the large groove 52 and the small groove 51 are all connected with a splice structure, which includes a first splice section and a second splice section, the first splice section corresponding to the second splice section.

By providing the first splice structure and the second splice structure at the ends of the blind 53, the large groove plate 52 and the small groove plate 51 respectively, the user can choose the number and size of the spliced plates according to his needs, which can meet the demand for personalisation.

### Embodiment 11

On the basis of Embodiment 8 or 9, it further includes a sealing rubber strip 631, the waterproof rubber strip is provided at the junction of the blind plate 53, the large groove plate 52 and the small groove plate 51.

The blind plate 53, the large groove plate 52 and the small groove plate 51 are all connected with a splice structure, the splice plate is connected with a first splice section or a second splice section, the first splice section or the second splice section is connected to one end of the splice plate, the first splice section is adapted to the second splice section.

The splice plate located in the middle (here the splice plate is a collective term for the blind 53, the large groove plate 52 and the small groove plate 51 is provided with a splice structure at both ends of the splice plate 5 as both ends need to be connected to the splice plate 5, therefore a splice structure has to be provided at both ends of the splice plate 5, usually only one side of the end splice plate 5 that needs to be connected to the splice plate 5, so only one splice section is needed.

### Embodiment 12

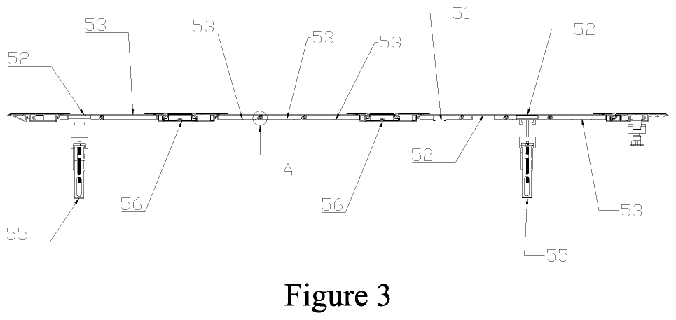

On the basis of Embodiment 10 or 11, as shown in FIGS. 3,7 and 8, the first splice section includes a sealing section 611 and a deformation section 613, the sealing section 611 is provided with a first flange 6111 and a second concave edge 6112, the deformation section 613 is provided with a thin wall section 6131 and a press pivot point 6132.

The second splice section includes a fitting section 621 and a clamping section 623, the fitting section 621 is provided with a first concave edge 6211 and a second flange 6212.

The first flange 6111 is adapted to the first concave edge 6211, the second flange 6212 is adapted to the second concave edge 6112, the press pivot point 6132 is provided in correspondence with the clamping section 623, the press pivot point 6132 is used to deform the deformation section 613 in contact with the clamping section 623.

The first flange 6111, the first concave edge 6211, the second flange 6212 and the second concave edge 6112 work together to form an “S”-shaped sealing structure through the cooperation of the sealing part 611 and the fitting section 621 with good waterproof effect.

By pushing the press pivot point 6132 and the thin wall section 6131, the deformation section 613 is deformed in the thin wall section 6131, which in turn clamps the first splice and the second splice to form the splice structure.

The second concave edge 6112 and the second flange 6212 are designed to increase stability, provide positioning of the splice and provide a certain degree of waterproofing.

### Embodiment 13

On the basis of Embodiment 12, the first splice section further includes an connection section 612, the sealing section 611 is connected to the deformation section 613 through the connection section 612, the thin wall section 6131 is provided between the press pivot point 6132 and the connection section 612.

The second splice section further includes an intermediate section 622, the fitting section 621 is connected to the clamping section 623 through the intermediate section 622.

### Embodiment 14

On the basis of Embodiment 13, the sealing section 611 is provided with a first rubber strip pressing surface 6113, the fitting section 621 is provided with a second rubber strip pressing surface 6213, a sealing rubber strip 631 is provided between the first rubber strip pressing surface 6113 and the second rubber strip pressing surface 6213.

The clamping section 623 is provided with a third flange 6231, the deformation section 613 is provided with a third concave edge 6134, the third flange 6231 is adapted to the third concave edge 6134, the third concave edge 6134 is provided at the end of the pressing pivot 6132 away from the thin wall section 6131, the deformation section 613 is connected to a clamping end 6133 at the end of the deformation section 613 away from the connection section 612, the clamping end 6133 is provided on the side of the deformation section 613 near the clamping section 623.

By providing the sealing rubber strip 631, and setting the first rubber strip pressing surface 6113 and the second rubber strip pressing surface 6213 on both sides of the sealing rubber strip 631, when the press pivot point 6132 is pressed, the first deformation transfer surface 6135 contacts the second deformation transfer surface 6232, while the third flange 6231 cooperates with the third concave edge 6134 and the clamping end 6133 contacts the clamping section 623, and continues to apply pressure to the press pivot point 6132 so that the clamping end 6133 hooks onto the third flange 6231, while the second splice section is deformed by the force, causing the rubber strip pressing surface to press against the sealing rubber strip 631, clamping the sealing rubber strip 631 between the first rubber strip pressing surface 6113 and the second rubber strip pressing surface 6213.

As the first flange 6111 is stuck inside the first concave edge 6211, and the clamping end 6133 also stuck with the clamping section 623, the two ends of the first splice structure clamps the second splice structure to realize the connection of the two splice structures.

When the press pivot point 6132 of the blind plate is squeezed, the thin-walled section 6131 is easily deformed, so that the deformation section 613 is deformed, the first deformation transfer surface 6135 applies force to the second deformation transfer surface 6232, causing the middle section 622 to deform, the second rubber strip press surface 6213 squeezes the sealing rubber strip 631, and the first rubber strip press surface 6113 presses the sealing rubber strip 631 in reverse, the sealing rubber strip 631 is deformed.

### Embodiment 15

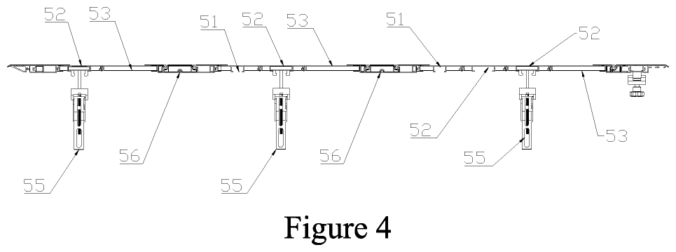

On the basis of Embodiment 7, as shown in FIG. 4, the splice plate groups include a first splice plate group, a second splice plate group and a third splice plate group, the first splice plate group and the second splice plate group are connected to each other by a rotating shaft system 56 and the second splice plate group and the third splice plate group are connected to each other by a rotating shaft system 56.

The first splice plate group includes a large groove plate 52 and a blind plate 53, the large groove plate 52 is connected to a wrench system 55.

The second splice plate group includes a small groove plate 51, a large groove plate 52 and a blind plate 53, the large groove plate 52 is connected between the small groove plate 51 and the blind plate 53, the large groove plate 52 is connected with a wrench system 55.

The third splice plate group includes a small groove plate 51, a blind plate 53 and two large groove plates 52, the two large groove plates 52 are connected to each other, the two large groove plates 52 are connected to a small groove plate 51 and a blind plate 53 respectively, one of the large groove plates 52 is connected with a wrench system 55.

### Embodiment 15

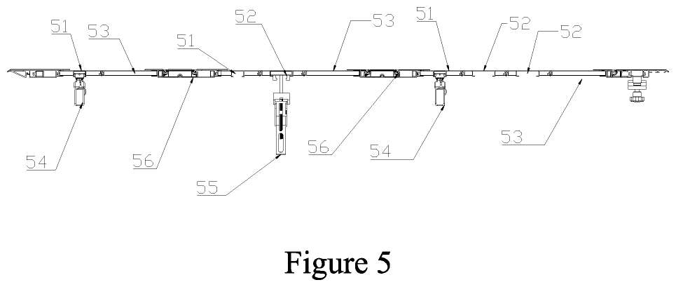

On the basis of Embodiment 7, as shown in FIG. 5, the splice plate group includes a first splice plate group, a second splice plate group and a third splice plate group, the first splice plate group and the second splice plate group are connected to each other by a rotating shaft system 56, the second splice plate group and the third splice plate group are connected to each other by a rotating shaft system 56.

The first splice plate group includes a blind plate 53 and a small groove plate 51, the small groove plate 51 is connected to a lock bolt system 54.

The second splice plate group includes a small groove plate 51, a large groove plate 52 and a blind plate 53, the large groove plate 52 is provided between the small groove plate 51 and the blind plate 53, the large groove plate 52 is provided with a wrench system 55.

The third splice plate group includes a small groove plate 51, a blind plate 53 and two large groove plates 52, the two large groove plates 52 are connected to each other, the two large groove plates 52 are connected to a small groove plate 51 and a blind plate 53 respectively, the small groove plates 51 are connected to a lock bolt system 54.

### Embodiment 17

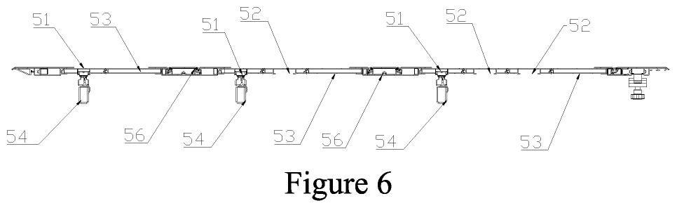

On the basis of Embodiment 7, as shown in FIG. 6, the splice plate group includes a first splice plate group, a second splice plate group and a third splice plate group, the first splice plate group and the second splice plate group are connected to each other by a rotating shaft system 56 and the second splice plate group and the third splice plate group are connected to each other by a rotating shaft system 56.

The first splice plate group includes a blind plate 53 and a small groove plate 51, the small groove plate 51 is connected with a lock bolt system 54.

The second splice plate group includes a small groove plate 51, a large groove plate 52 and a blind plate 53, the large groove plate 52 is provided between the small groove plate 51 and the blind plate 53, the small groove plate 51 is connected with a lock bolt system 54.

The third splice plate group includes a small groove plate 51, a blind plate 53 and two large groove plates 52, the two large groove plates 52 are connected to each other, the two large groove plates 52 are connected to a small groove plate 51 and a blind plate 53 respectively, the small groove plate 51 is connected with a lock bolt system 54.

### Embodiment 18

As shown in FIGS. 2 and 3, a splice plate car cover includes a plurality of splice plate groups, with two adjacent splice plate groups connected to each other by a rotating shaft system 56, the splice plate groups include any one or a combination of blind plate 53, a large groove plate 52, a small groove plate 51, the large groove plate 52 and the small groove plate 51 are used for connecting the plate fixing system. The large groove plate 52 and the small groove plate 51 can be fitted with different sizes of plate fixing systems, with a splice plate wrench system 55 or with a splice plate lock bolt system 54, and are not limited to whether they are fitted to the large groove plate 52 or the small groove plate 51 according to demand. the width dimensions of the splice large groove plate 52, the splice small groove plate 51 and the blind plate 53 as described are not at least identical.

By setting the splice plate, it can be adapted accordingly to the user's needs and meet the individual needs of different users.

The splicing plate group can include only any one of the blind plate 53, the large groove plate 52, the small groove plate 51, or any two of the blind plate 53, the large groove plate 52 and the small groove plate 51.

The width of each splice plate 5 may or may not be identical.

### Embodiment 19

On the basis of Embodiment 18, as shown in FIG. 1, it further includes a front fixing bracket 1, a left fixing bracket 2, a rear fixing bracket 3 and a right fixing bracket 4, the front fixing bracket 1 and rear fixing bracket 3 are respectively connected to the opposite ends of the splice plate group 5, the left fixing bracket 2 and the right fixing bracket 4 are respectively connected to the other two ends of the splice plate group 5. The large groove splice plate 52 and small groove plate 51 can be installed without the fixing system, which is mounted on the front fixing bracket 1 or the rear fixing bracket 3.

The invention is not limited to the above-mentioned optional embodiments. Anyone can come up with various other forms of products under the inspiration of the invention, however, regardless of any changes in its shape or structure. All technical solutions that fall within the scope defined by the claims of the present invention shall fall within the scope of protection of the invention.

1. A splice plate car cover, wherein, includes a splice plate group (5), the splice plate group (5) includes any combination of a blind plate (53), a large groove plate (52) and a small groove plate (51), the large groove plate (52) and the small groove plate (51) are used to connect the plate fixing system.

2. A splice plate car cover, wherein, includes splice plate group (5), the splice plate group (5) includes any combination of a blind plate (53) and a large groove plate (52), the large groove plate (52) is used to connect the plate fixing system.

3. A splice plate car cover, wherein, includes a splice plate group (5), the splice plate group (5) includes any combination of a blind plate (53) and a small groove plate (51), the large groove plate (52) are used to connect the plate fixing system.

4. A splice plate car cover, wherein, includes a splice plate group (5), the splice plate group (5) includes any combination of a large groove plate (52) and a small groove plate (51), the small groove plate (51) and the large groove plate (52) are used to connect the plate fixing system.

5. A splice plate car cover, wherein, includes a splice plate group (5), the splice plate group (5) includes at least one large groove plate (52), the large groove plate (52) is used to connect the plate fixing system.

6. A splice plate car cover, wherein, includes a splice plate group (5), the splice plate group (5) includes at least one small groove plate (51), the small groove plate (51) is used to connect the plate fixing system.

7. A splice plate car cover, wherein, includes a splice plate group (5), the splice plate group (5) includes at least one blind plate (53).

8. A splice plate car cover, wherein, includes a front fixing bracket (1), a left fixing bracket (2), a rear fixing bracket (3), a right fixing bracket (4) and a splice plate group (5), the front fixing bracket (1) and the rear fixing bracket (3) are respectively connected to two ends of the splice plate group (5), the left fixing bracket (2) and the right fixing bracket (4) are respectively connected to the other two ends of the splice plate group (5), the splice plate group (5) includes at least one splicing blind (53), the plate fixing system is connected to the front fixing bracket (1) or rear fixing bracket (3).

9. A splice plate car cover, wherein, includes a plurality of splice plate groups, with two splice plate groups connected by a rotating shaft system (56), the splice plate groups include any one or a combination of a blind plate (53), a large groove plate (52) and a small groove plate (51), the large groove plate (52) and the small groove plate (51) are used for connecting the plate fixing system.

10. A splice plate car cover according to claim 1, wherein, the plate fixing system includes any one or a combination of a wrench system (55), a plate fixing system and a lock bolt system (54).

11. A splice plate car cover according to claim 1, wherein, it further includes a front fixing bracket (1), a left fixing bracket (2), a rear fixing bracket (3) and a right fixing bracket (4), the front fixing bracket (1) and the rear fixing bracket (3) are respectively connected to the two opposite ends of the splice plate group (5), the left fixing bracket (2) and the right fixing bracket (4) are respectively connected to the other two ends.

12. A splice plate car cover according to claim 10, wherein, it also includes a sealing rubber strip (631), the waterproof rubber strip is provided at the junction of the blind plate (53), the large groove plate (52), the small groove plate (51).

13. A splice plate car cover according to claim 12, wherein, the blind plate (53), the large groove plate (52) and the small groove plate (51) are connected with a splice structure, the splice structure includes a first splice section and/or a second splice section.

14. A splice plate car cover according to claim 13, wherein, the first splice section includes a sealing section (611) and a deformation section (613), the sealing section (611) is provided with a first flange (6111) and a second concave edge (6112), the deformation section (613) is provided with a thin wall section (6131) and a press pivot point (6132);
The second splice section includes a fitting section (621) and a clamping section (623), the fitting section (621) is provided with a first concave edge (6211) and a second flange (6212);
The first flange (6111) is adapted to the first concave edge (6211), the second flange (6212) is adapted to the second concave edge (6112), the press pivot point (6132) is provided in correspondence with the clamping section (623), the press pivot (6132) is used to deform the deformation section (613) into contact with the clamping section (623).

15. A splice plate cover according to claim 14, wherein, the first splice section further includes a connection section (612), the sealing section (611) is connected to the deformation section (613) through the connection section (612), the thin wall section (6131) is provided between the pressing pivot point (6132) and the connection section (612);
The second splice section further includes an intermediate section (622), through which the fitting section (621) is connected to the clamping section (623).

16. A splice plate car cover according to claim 15, wherein, the sealing section (611) is provided with a first rubber strip pressing surface (6113), the fitting section (621) is provided with a second rubber strip pressing surface (6213), the sealing rubber strip (631) is located between the first rubber strip pressing surface (6113) and the second rubber strip pressing surface (6213);
The clamping section (623) is provided with a third flange (6231), the deformation section (613) is provided with a third concave edge (6134), the third flange (6231) is adapted to the third concave edge (6134), the third concave edge (6134) is provided at the end of the press pivot (6132) away from the thin wall section (6131), the end of the deformation section (613) away from the connection section (612) is connected with a clamping end (6133), the clamping end (6133) is provided on the side of the deformation section (613) near the clamping section (623).

17. A splice plate car cover according to claim 16, wherein, the splice plate group includes a first splice plate group, a second splice plate group and a third splice plate group, the first splice plate group and the second splice plate group are connected to each other by a rotating shaft system (56), the second splice plate group and the third splice plate group are connected to each other by a rotating shaft system (56).

18. A splice plate car cover according to claim 17, wherein, the first splice plate group includes a large groove plate (52) and a blind plate (53), the large groove plate (52) is connected with a wrench system (55);
the second splice plate group includes a small groove plate (51), a large groove plate (52) and a blind plate (53), the large groove plate (52) is connected between the small groove plate (51) and the blind plate (53), the large groove plate (52) is connected with a wrench system (55);
The third splice plate group includes a small groove plate (51), a blind plate (53) and two large groove plates (52), the two large groove plates (52) are connected to each other, the two large groove plates (52) are respectively connected with a small groove plate (51) and a blind plate (53), one of the large groove plates (52) is connected with a wrench system (55).

19. A splice plate car cover according to claim 17, wherein, the first splice plate group includes a blind plate (53) and a small groove plate (51), the small groove plate (51) is connected with a lock bolt system (54);
The second splice plate group includes a small groove plate (51), a large groove plate (52) and a blind plate (53), the large groove plate (52) is connected between the small groove plate (51) and the blind plate (53), the large groove plate (52) is connected with a wrench system (55);
The third splice plate group includes a small groove plate (51), a blind plate (53) and two large groove plates (52), the two large groove plates (52) are connected to each other, the two large groove plates (52) are respectively connected to a small groove plate (51) and a blind plate (53), the small groove plate (51) is connected to a lock bolt system (54).

20. A splice plate car cover according to claim 17, wherein, the first splice plate group includes a blind plate (53) and a small groove plate (51), the small groove plate (51) is connected with a lock bolt system (54);
The second splice plate group includes a small groove plate (51), a large groove plate (52) and a blind plate (53), the large groove plate (52) is connected between the small groove plate (51) and the blind plate (53), the small groove plate (51) is connected with a lock bolt system (54)
The third splice plate group includes a small groove plate (51), a blind plate (53) and two large groove plates (52), the two large groove plates (52) are connected to each other, the two large groove plates (52) are respectively connected to a small groove plate (51) and a blind plate (53), the small groove plate (51) is connected to a lock bolt system (54).
